(19) United States
(12) Patent Application Publication
(10) Pub. No.: US 2005/0286629 A1
(43) Pub. Date: Dec. 29, 2005

(54) Coding of scene cuts in video sequences using non-reference frames

(76) Inventors: Adriana Dumitras, Sunnyvale, CA (US); Barin Geoffry Haskell, Mountain View, CA (US)

Correspondence Address: KENYON & KENYON, 1500 K STREET NW, SUITE 700, WASHINGTON, DC, 20005, US

(21) Appl. No.: 10/875,265

(22) Filed: Jun. 25, 2004

(51) Int. Cl. H04B 1/66; H04N 5/14; H04N 11/02; H04N 9/64; H04N 11/04; H04N 7/12

(52) U.S. Cl. 375/240.03; 375/240.01; 348/700; 375/240.15

(57) ABSTRACT

A coding scheme for groups of frames that include scene cuts causes frames before and after the scene cut to be coded as non-reference frames with increased quantization parameters to reduce bandwidth. Although greater coding distortion can be expected for such frames, the distortion should be less or even not perceptible to a viewer owing to the dynamically changing image content caused by the scene change. Quantization parameter increases may vary based on: a viewing rate expected at a decoder, proximity of a frame to the scene cut, and observable motion speed both before and after the scene cut. Additionally, non-reference frames in the GOF may be coded using spatial direct mode coding.

### BACKGROUND

In a video coding system, such as that illustrated in FIG. 1, an encoder compresses input video data. The resulting compressed sequence (bitstream) is conveyed to a decoder 120 via a channel 130, which can be a transmission medium or a storage device such as an electrical, magnetic or optical memory. To utilize the video data, the bitstream is decompressed at the decoder 120, yielding a decoded video sequence. While standards compliant video systems in the MPEG and ITU-T families of standards specify completely the characteristics of the decoder 120, the design of the encoder 110 allows for great flexibility. Consequently, intensive work has been carried out in optimizing the encoder, with the objective of reducing the size of the compressed bitstream while ensuring that the decoded sequence has good visual quality. The size of the compressed bitstream is directly related to the bit rate, which determines how much channel capacity is occupied by the bitstream.

Video encoder optimization for bit rate reduction of the compressed bitstreams and high visual quality preservation of the decoded video sequences encompasses solutions such as scene cut detection, frame type selections, rate-distortion optimized mode decisions and parameter selections, background modeling, quantization modeling, perceptual modeling, analysis-based encoder control and rate control. This disclosure focuses on coding of scene cuts at the encoder 110.

Introduction to Frame Types and Coding Techniques

Many video coding algorithms first partition each picture into small subsets of pixels, called “pixelblocks” herein. Then each pixelblock is coded using some form of predictive coding method such as motion compensation. Some video coding standards, e.g., ISO MPEG or ITU H.264, use different types of predicted pixelblocks in their coding. In one scenario, a pixelblock may be one of three types: Intra (I) pixelblock that uses no information from other pictures in its coding, Unidirectionally Predicted (P) pixelblock that uses information from one preceding picture, and Bidirectionally Predicted (B) pixelblock that uses information from one preceding picture and one future picture. By convention, data from I and P pictures are a source of prediction for other frames but B pictures typically are not. Accordingly, herein, I and P pictures are called “reference frames” and B frames are called “non-reference frames.”

Consider the case where all pixelblocks within a given picture are of the same type.

Thus, a sequence of pictures to be coded might be represented as:
I1 B2 B3 B4 P5 B6 B7 B8 B9 P10 B11 P12 B13 I14
   in display order. This is shown graphically in FIG. 2, where I, P, B indicate the picture type, and the number indicates the camera or display order in the sequence. In this scenario, picture I1 uses no information from other pictures in its coding. P5 uses information from I1 in its coding. B2, B3, B4 all use information from both I1 and P5 in their coding. Arrows in FIG. 2 indicate that pixels from a reference picture (I or P in this case) are used in the motion compensated prediction of other pictures.

Since B pictures use information from future pictures, the transmission order is usually different than the display order. For the above sequence, the transmission order, which is illustrated graphically in FIG. 2, might occur as:
I1 P5 B2 B3 B4 P10 B6 B7 B8 B9 P12 B11 I14 B13
   Thus, when it comes time to decode B2 for example, the decoder 120 will have already received and stored the information in I1 and P5 necessary to decode B2, similarly B3 and B4. The decoder 120 also reorders the sequence for proper display. The coding of the P pictures typically utilizes motion compensation predictive coding, wherein a motion vector is computed for each pixelblock in the picture. Using the motion vector, a prediction pixelblock can be formed by translation of pixels in the aforementioned previous picture. The difference between the actual pixelblock in the P picture and the prediction block is then coded for transmission.

Each motion vector may also be transmitted via predictive coding. That is, a prediction is formed using nearby motion vectors that have already been sent, and then the difference between the actual motion vector and the prediction is coded for transmission. Each B pixelblock typically uses two motion vectors, one for the aforementioned previous picture and one for the future picture. From these motion vectors, two prediction pixeiblocks are computed, which are then averaged together to form the final prediction. As above, the difference between the actual pixelblock in the B picture and the prediction block is coded for transmission. As with P pixelblocks, each motion vector of a B pixelblock may be transmitted via predictive coding. That is, a prediction is formed using nearby motion vectors that have already been transmitted, and then the difference between the actual motion vector and the prediction is coded for transmission.

However, with B pixelblocks, an opportunity exists for interpolating the motion vectors from those in the co-located or nearby pixelblocks of the stored pictures. The interpolated value may then be used as a prediction and the difference between the actual motion vector and the prediction coded for transmission. Such interpolation is carried out both at the encoder 110 and decoder 120.

In some cases, the interpolated motion vector is good enough to be used without any correction, in which case no motion vector data need be sent. This is referred to as “Direct Mode” in H.263 and H.264. Direct mode coding works particularly well, for example, for video generated by a camera that slowly pans across a stationary background. In fact, the interpolation may be good enough to be used as is, which means that no differential information need be transmitted for these B pixelblock motion vectors.

Within each picture, the pixelblocks may also be coded in many ways. For example, a pixelblock may be divided into smaller sub-blocks, with motion vectors computed and transmitted for each sub-block. The shape of the sub-blocks may vary and not be square.

Pixelblocks are not always coded according to their picture type. Within a P or B picture, some pixelblocks may be better coded without using motion compensation, i.e., they would be coded as Intra (I) pixelblocks. Within a B picture, some pixelblocks may be better coded using unidirectional motion compensation, i.e., they would be coded as forward predicted or backward predicted depending on whether a previous picture or a future picture is used in the prediction.

Prior to transmission, the prediction error of a pixelblock or sub-block typically is transformed by an orthogonal transform such as a Discrete Cosine Transform, a wavelet transform or an approximation thereto. The transform operation generates a set of transform coefficients equal in number to the number of pixels in the pixelblock or sub-block being transformed. At the decoder 120, the received transform coefficients are inverse transformed to recover the prediction error values to be used further in the decoding.

Not all the transform coefficients need be transmitted for acceptable video quality.

Depending on the transmission bit rate available, more than half, sometimes much more than half, of the transform coefficients may be deleted and not transmitted. At the decoder 120, their values are replaced by zeros prior to inverse transform. Also, prior to transmission the transform coefficients are typically quantized and entropy coded. Quantization involves representation of the transform coefficient values by a finite subset of possible values, which reduces the accuracy of transmission and often forces small values to zero, further reducing the number of coefficients that are sent. In quantization typically, each transform coefficient is divided by a quantizer step size Q and rounded to the nearest integer. For example, the transform coefficient Coeff would be quantized to the value Coeff_{q} by Coeff_{q}=(Coeff+Q/2)/Q truncated to an integer.

The integers are then entropy coded using variable word-length codes such as Huffman codes or arithmetic codes. The sub-block size and shape used for motion compensation may not be the same as the sub-block size and shape used for the transform. For example, 16×16, 16×8, 8×16 pixels or smaller sizes are commonly used for motion compensation whereas 8×8 or 4×4 pixels are commonly used for transforms. Indeed the motion compensation and transform sub-block sizes and shapes may vary from pixelblock to pixelblock.

Frame Type Decision

A video encoder 110 must decide what is the best way amongst all of the possible methods (or modes) to code each pixelblock. This is known as the “mode selection problem”, and many ad hoc solutions have been used. The combination of transform coefficient deletion, quantization of the transform coefficients that are transmitted and mode selection leads to a reduction of the bit rate used for transmission. It also leads to distortion in the decoded video.

A video encoder 110 must also decide how many B pictures, if any, are to be coded between each I or P picture. This is known as the “frame type selection problem”, and again, ad hoc solutions have been used. Typically, if the motion in the scene is very irregular or if there are frequent scene changes, then very few, if any, B pictures should be coded. On the other hand, if there are long periods of slow motion or camera pans, then coding many B-pictures will result in a significantly lower overall bit rate.

A brute force approach would code every combination of B pictures and pick the combination that minimizes the bit rate. However, this method is usually far too complex. It also requires a very large number of trial-and-error operations, most of which must be discarded once a final decision is made.

A more efficient approach to achieve the I/P/B decision uses the motion characteristics of the sequence. The inventors previously proposed a method that achieves I/P/B decisions using motion vectors and requires a single threshold value that can be maintained the same for all sequences. The main idea of the proposed method is to evaluate the motion speed error (differences) over successive frames. When the motion speed error is very small, the speed is almost constant and therefore a higher number of B frames can be assigned. When a discontinuity in motion speed is observed, the GOF is terminated. The last frame of the GOF is coded as a reference frame. The GOF typically possesses a BB . . . BP or a BB . . . BI structure (considered in display order).

Scene Cut Detection

As stated earlier, scene cuts are identified at the encoder 110 using a scene detection method. Numerous such methods have been proposed for a wide range of applications. In one scheme, scene changes are identified using a difference of histograms distance metric on the luminance frames as a measure of frame correlation. When the time from the current frame to the last reference frame exceeds a threshold, a P reference frame is inserted. Alternatively, a histogram of difference image, a block histogram difference and a block variance difference are employed to detect changes in the video content. Alternative methods for scene cut detection have been employed in applications such as retrieval, temporal segmentation and semantic video description. Typically, differences of gray-level sums, sums of gray level differences, differences of gray level histograms, differences of color histograms, motion discontinuities, entropy measures have been employed.

Fewer works employ statistical detection theory, phase correlation or filtering for scene change detection. The use of color information did not improve the detection results as compared to those obtained using only gray level information. Finally, other works perform scene change detection in the compressed domain. When applied at the encoder, their methods would require full encoding of the frames and then re-encoding after the decision on P or B pictures. These solutions are computationally expensive.

The effectiveness of a scene cut detector is evaluated using the rate of correct classification (RCC) (number of scene cuts identified correctly) and the rate of misclassification (RMC), given by:

$$\begin{matrix}RCC [ \% ] = \frac{\vert \{ s \vert s ∈ D AND s ∈ R \} \vert}{\vert R \vert} \times 100 & ( 1 ) \\ RMC [ \% ] = \frac{\vert \{ s \vert s ∈ D AND s ∉ R \} \vert}{\vert R \vert} \times 100 & ( 2 )\end{matrix}$$

where ∥ and s denote the set of all test sequences and the cardinality operator, respectively.

Notations D and R stand for the number of detected scene cuts and the actual number of scene cuts in the sequence, respectively. In other words, the rate of correct classification measures the percentage of scene cuts detected correctly (the number of scene cuts that belong to the class of detected scene cuts and are also scene cuts that exist in the sequence) out of a total number R of scene cuts in the sequence. The rate of misclassification measures the percentage of scene cuts detected incorrectly (the number of scene cuts that belong to the class of detected scene cuts but are not scene cuts that exist in the sequence) out of a total number R of scene cuts in the sequence. Other measures of performance for scene cut detectors include the rate of misses (RM) defined as the number of scene cuts that are present in the sequence but have not been identified, and the rate of false alarms (RFA) defined as the number of scene cuts identified without being present in the sequence.

Coding of Scene Cuts

Assume that a scene cut is present between frames n and n+1. Possible coding scenarios considered in prior art include the following:

A frame n+1 (frame immediately after a scene cut) is coded as a reference I frame. This is motivated by the desire to avoid coding frames n+2, n+3, and so on, with reference to a frame n that occurs before the scene cut, as the correlation between these frames and frame n should be low.

Most works have opted to code frame n+1 as an I frame with full resolution. However, this solution increases the bit rate for sequences with numerous scene cuts. Therefore, motivated by the temporal masking of the human visual system, which does not distinguish the graceful degradation of the visual quality in the frames after the scene cut under full frame rate conditions, solutions to encode frame n+1 as a coarse I frame by increasing the quantization also have been proposed. The frame types of other frames that are close to the scene cut are not modified.

Alternatively, prior solutions propose to code frame n+1 (frame immediately after a scene cut) as a reference P frame. This is an approximation to using an I frame. In fact, numerous pixelblocks of the P frame n+1 are coded as intra blocks. Overall, a P frame will rarely require more bits than an I frame. In the case of sequences with frequent scene cuts such as movie trailers, numerous frames are coded as P frames anyway. Therefore coding the frame after each scene cut as a P frame may be more efficient than coding the same frame as an I frame, while the visual quality of the decoded sequences does not seem to be affected. The P frame may be coded at full quality or low quality.

In addition to coding the frame n+1 as an I frame (discussed above), some solutions propose to code the frame n (frame immediately before a scene cut) as a reference frame (I or P frame). In one solution, the frame before the scene cut is coded as a coarse P frame, thus exploiting the backward temporal masking effect in human vision. This effect limits the perception of visual degradation in the frames before a scene cut under full frame rate viewing conditions. In this case, the frame types for frames n and n+1 are modified, the frame types of other frames that are close to the scene cut are not changed.

In light of the above, once a scene cut detector identifies the position of a scene cut, an encoder's frame type decision unit indicates that the frame immediately after the scene cut is to be coded as a reference frame. Since a reference frame typically requires more bits to code than a non-reference frame, this decision results in higher bit rates for video sequences that contain numerous scene cuts such as video clips/MTV content, trailers, action movies, etc.

Moreover, the bit rate also increases as a result of any “false alarms,” i.e., frames incorrectly identified as having a scene cut, because a reference frame would be inserted where it otherwise would not be required. To address these problems, the inventors propose a method to encode the scene cuts in a video sequence using non-reference frames.

### BRIEF DESCRIPTION OF THE DRAWINGS

FIG. 1 illustrates a coder/decoder system.

FIG. 2 illustrates exemplary frames considered in display order.

FIG. 3 illustrates the exemplary frames of FIG. 2 considered in coding order.

FIG. 4 is a functional block diagram of a coding system according to an embodiment of the present invention.

FIG. 5 is a diagram of a method according to an embodiment of the present invention.

FIG. 6 provides graphs illustrating exemplary quantizer parameter adjustment values for different coding scenarios according to an embodiment of the present invention.

FIG. 7 provides graphs illustrating exemplary quantizer parameter adjustment values for another set of coding scenarios according to an embodiment of the present invention.

FIG. 8 is a simplified block diagram of a computer system suitable for use with the present invention.

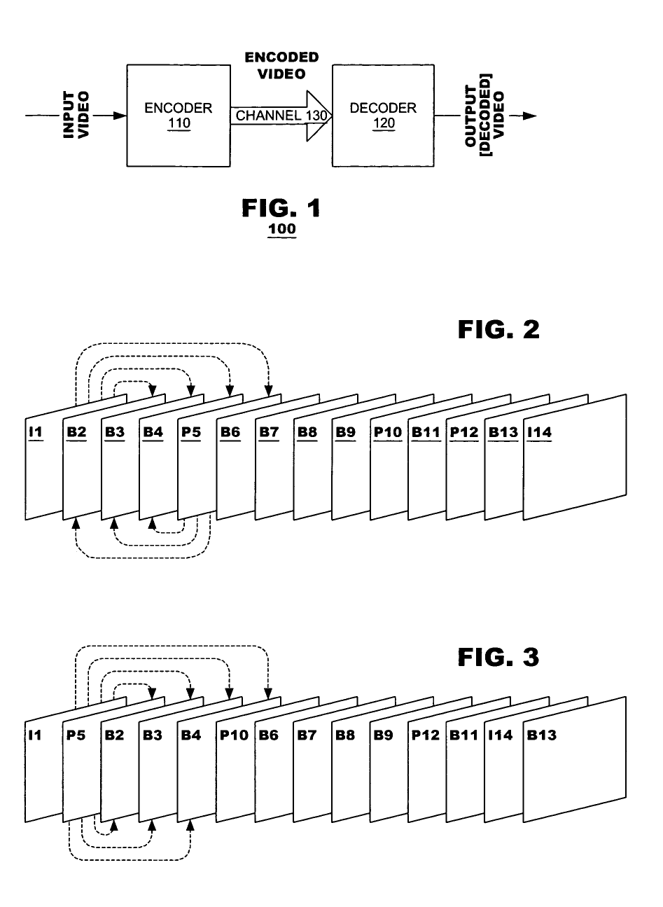

### DETAILED DESCRIPTION

Embodiments of the present invention provide a coding scheme for groups of frames that include scene cuts. Frames from GOFs that include scene cuts may be coded as non-reference frames with different quantization parameters to reduce bandwidth. Although greater coding distortion can be expected for such frames, the distortion should be less perceptible, even imperceptible, to a viewer owing to the dynamically changing image content caused by the scene change. Quantization parameter changes may vary based on: a viewing rate expected at a decoder, proximity of a frame to the scene cut, and observable motion speed both before and after the scene cut. Additionally, non-reference frames in the GOF may be coded using spatial direct mode coding.

As noted, a GOF possesses a B . . . BP or a B . . . BI structure when considered in display order. So long as adjacent frames exhibit common motion speed, they may be included in a common GOF and coded as non-reference frames. When a frame exhibits an inconsistent motion speed, it can be added to a GOF and coded as a reference frame. The GOF terminates.

Embodiments of the present invention represent an exception to the default rules for building GOFs. A scene change often introduces abrupt changes in motion speed when compared to the frames that precede it. Ordinarily, a GOF might be terminated when a scene change occurs. According to an embodiment, however, if a scene cut is detected, the GOF may be extended beyond the scene cut by a predetermined number of frames (e.g., 2 or 3 frames) and terminated. The terminal frame of the GOF may be coded as a reference frame and the frames immediately adjacent to the scene cut may be coded as non-reference frames.

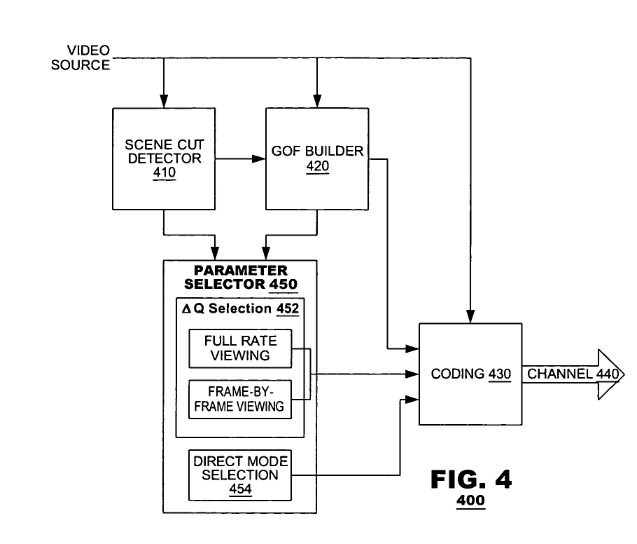

FIG. 4 is a functional block diagram of a coding system 400 according to an embodiment of the present invention. The system 400 may include a scene cut detector 410, a GOF builder 420 and a coding unit 430, each coupled to a common source of video data. The scene cut detector 410, as its name implies, examines image data from a video sequence and determines when scene cuts occur between frames. The GOF builder 420 decides frame coding types for each of the frames in a video sequence. Frames may be classified, for example, as I frames, P frames or B frames as discussed above. The coding unit 430 codes pixelblocks from the video sequence according to the frame type decision applied to frames within the video sequence. Coded video data may be output to a channel, typically a communication medium or storage medium.

The scene cut detector 410 may operate according to any of the schemes that are known in the art. For instance, scene cut detector 410 may compare co-located pixels from at least two adjacent frames to determine degrees of similarity between them. A low degree of similarity between two frames may indicate that a scene cut occurred.

In one example, the scene cut detector 410 may generate a correlation coefficient between two adjacent frames, given by:

$$C = \frac{{\sum }_{i = 1}^{M} {\sum }_{j = 1}^{N} {F}_{n} ( i , j ) {F}_{n + 1} ( i , j )}{{( {\sum }_{i = 1}^{M} {\sum }_{j = 1}^{N} {F}_{n}^{2} ( i , j ) {\sum }_{i = 1}^{M} {\sum }_{j = 1}^{N} {F}_{n + 1}^{2} ( i , j ) )}^{1 / 2}} , \qquad ( 3 )$$

where n, n+1 are two adjacent frames, F(•) represents a pixel value, (i,j) represents a pixel location within each frame and M, N, respectively, represent the width and weight of the frames in pixels. Small values of the correlation coefficient C indicate the occurrence of a scene change.

The GOF builder 420 may determine what frame types are to be applied to frames from the video sequence according to the GOF build process. As noted, the most common types of frames are I frames, P frames and B frames. Thus, the GOF builder 420 may build GOFs based upon comparisons of motion speed among pixelblocks in the video sequence. When a series of frames exhibits generally consistent motion speed among them, the frames can be included in a common GOF and can be assigned to be B frames for coding purposes. Thus, the GOF can be built iteratively, considering each new frame against the frames in the GOF that preceded it. When a new frame exhibits inconsistent motion speed with respect to other frames already in the GOF, the new frame can be designated a P frame for coding purposes and the GOF concludes. Such techniques are described in detail in the inventors' co-pending application Ser. No. 10/743,722, filed Dec. 24, 2003 and assigned to Apple Corp., the assignee of the present application.

The coding unit 430 codes the image data itself. As described, such image coding includes organizing the pixel data within the frame into pixelblocks, transforming the pixelblock data and quantizing and coding transform coefficients obtained therefrom. Quantization, for example, divides coefficient values by a quantizer step value, causing many of the coefficients to be truncated to zero. For example, the MPEG coding standards and H.261, H.262 and H.263 standards are based on this coding structure.

Coded video data generated by the coding unit 430 may be output to a channel 440 and further to a decoder (not shown). The channel may be a communication channel, such as those provided by a computer network or a communication network. Alternatively, the channel 440 may be a storage device such as an electronic, magnetic or optical memory device.

The system 400 also may include a parameter selection unit 450, which may define coding parameters for use in GOFs in which scene cuts are detected. Higher quantizer levels can yield greater bandwidth reduction in a coded video signal but they also can increase coding artifacts (distortion in a recovered signal). Typically, the coding unit 430 itself has defined base quantizer parameter values for use. Quantizer values may be defined separately for I frames, P frames and B frames. According to an embodiment, the parameter selection unit 450 may generate a quantizer parameter adjustment (ΔQ) that supplements the base quantization parameter values to achieve additional bandwidth savings (e.g., the coding unit 430 uses a Q′=Q+ΔQ). The parameter selection unit 450 may vary the quantizer parameter adjustments in a context-sensitive manner based on the presence of a scene cut, a frame's proximity to a scene cut and/or observable complexity in the image data of frames surrounding a scene cut (described below).

Additionally, for B frames within a GOF, a parameter selector 450 may dictate that all or a select subset of pixelblocks are to be coded using a spatial direct mode technique. Whereas temporal direct mode coding causes a pixelblock to be coded using a scaled representation motion vectors from a co-located pixelblock from a reference frame, spatial direct mode coding causes a motion vector of a present pixelblock to be coded using motion vectors from a neighboring pixelblock from the same frame. Spatial mode coding may occur, for example, as defined in ISO/IEC 14496-10: “Information technology—coding of audio-visual objects—Part 10: Advanced Video coding;” also ITU-T Recommendation H.264: “Advanced video coding for generic audiovisual services,” 2003.

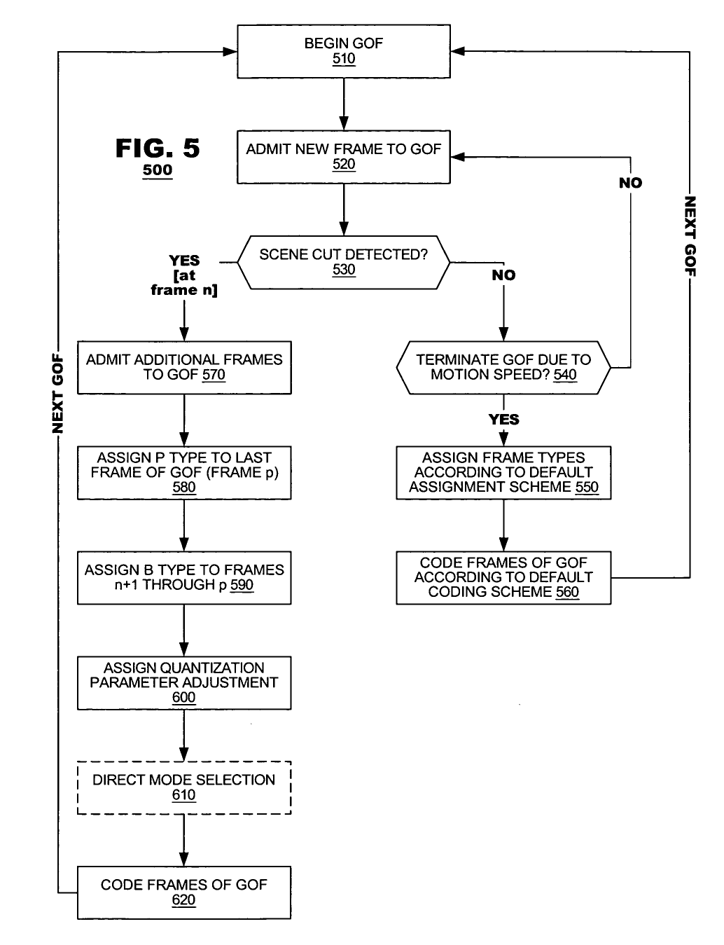

FIG. 5 illustrates a method 500 according to an embodiment of the present invention.

The method 500 may begin a new GOF (box 510) and admit a new frame to the GOF (box 520) according to conventional processes. Thereafter, the method 500 may determine whether a scene cut exists between the newly admitted frame and the frame that preceded it (box 530). If not, the method 500 determines whether to terminate the current GOF due to a motion speed change (box 540). If not, the method returns to box 520, admits another frame and repeats operation. If the method terminates the GOF, the method assigns frame types to the frames therein and codes them.

When a scene cut is detected at box 530, the method 500 admits a predetermined number of additional frames to the GOF (box 570). It assigns the last of the admitted frames to be a P frame (box 580). All frames adjacent to the scene cut and through to the last of the admitted frames are assigned to be B frames (box 590). The method also assigns quantization parameter adjustments to the frames of the GOF (box 600). In an embodiment, the method 500 also may select the coding mode for B frames in the GOF to be spatial mode coding (box 610). Thereafter, the method 500 codes the frames of the GOF according to their frame types, quantization parameter adjustments and, optionally, coding mode (box 620). The method may return to box 510 and repeat operation until the video sequence concludes.

In another embodiment, the quantizer parameter adjustment may vary based on a distance of each frame to the scene cut. For example, the quantizer parameter adjustment may be greatest for those frames that follow or precede the scene cut immediately, where image artifacts may not be noticeable. If the scene cut were identified between frames n and n+1, those frames may have the highest quantizer parameter adjustment. The quantizer parameter adjustment may decrease for frames n+2, etc., until the end of a GOF is reached. In some embodiments, it may be preferable to set the quantizer parameter adjustment to zero at a certain frame distance from the scene cut, if the end of the GOF were not reached.

The quantizer parameter adjustment also may be based on relative motion differences detected in video segments both before and after a scene cut. If motion both before and after a scene cut is relatively still, then the image quantizer parameter adjustment may be adjusted downward because coding artifacts might be perceived more easily. For relatively high levels of motion before and after a scene cut, particularly motion in different spatial directions, coding artifacts are less perceptible and therefore a higher quantizer adjustment may be used.

The graphs of FIG. 6 provide examples of such phenomena. Graph (a) depicts quantizer parameter adjustment that may occur when frames exhibit a very high degree of correlation to one another, despite the detection of a scene cut between frames n and n+1 (C≧0.9). In this scenario, quantizer parameter adjustments may be selected to be quite low. Indeed, for frames n−3 through n, the quantizer parameter adjustment is shown as set to zero. For frames n+1 and n+2, however, the quantizer parameter may be adjusted higher due to the interruption in image data. For frames at increasing distances from the scene cut, e.g., frame n+3, the quantizer parameter adjustment may be reduced.

Graph (b) illustrates a quantizer adjustment that might occur for frames that exhibit moderate levels of correlation (0.7<C<0.9). In this scenario, a relatively constant quantizer parameter adjustment may be used. Graph (b) for example, illustrates a ΔQ value of 1 for all B frames in the GOF.

For lower correlation levels (C≦0.7), more aggressive quantizer parameter adjustments may be used. B frames preceding the scene cut are shown as having a ΔQ=1 value applied. B frames that follow the scene cut are shown being adjusted to ΔQ=2 or ΔQ=3. For higher frame rates, e.g., 20 frames per second or more, the higher quantizer parameter adjustment may be used. For lower frame rates, the lower quantizer parameter may be used.

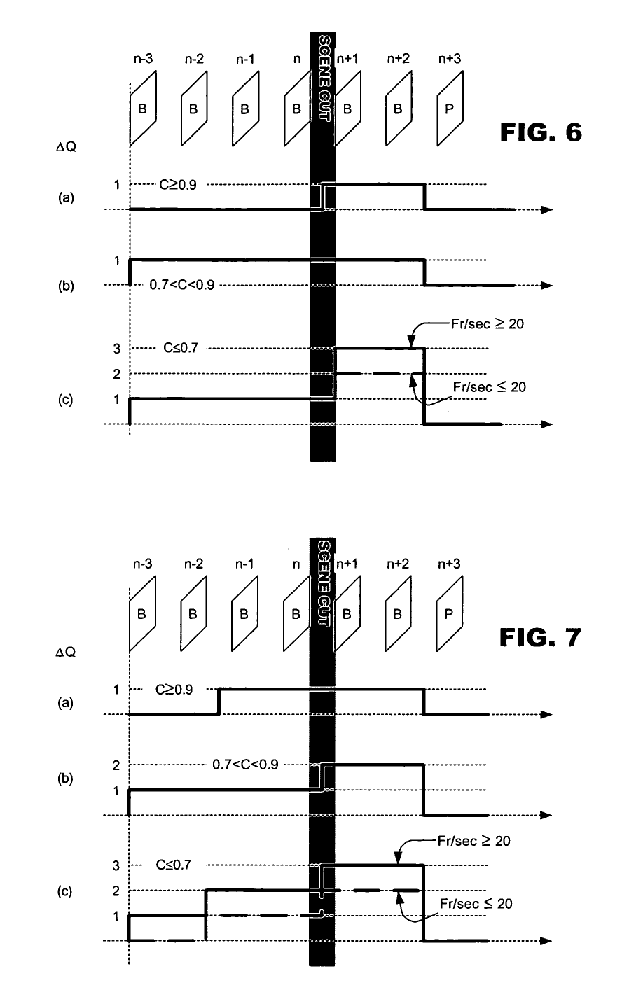

FIG. 7 illustrates another exemplary set of quantizer parameter adjustments. Graph (a) illustrates quantization parameter adjustments when a high degree of correlation exists among the frames (C≧0.9). Graph (b) illustrates quantizer parameter adjustments that could be used for moderate levels of correlation (0.7<C<0.9) and graph (c) illustrates quantizer parameter adjustments for lower correlation levels (C≦0.7).

In an embodiment, one might apply the quantizer parameter adjustments of FIG. 6 for coding scenarios where frame-by-frame viewing might be used on playback but apply the quantizer parameter adjustments of FIG. 7 where full rate viewing is expected for playback. Comparing the graphs of FIGS. 6 and 7 having common correlation levels, the quantizer parameter adjustments are larger in the full frame rate viewing case than in the frame-by-frame viewing case.

The foregoing discussion has presented operation of a video coding system in connection with a functional block diagram. In practice, the video coding system of the foregoing embodiments may be embodied in a variety of processing circuits. In one embodiment, the video coder may be embodied in a general purpose processor or digital signal processor with software control representing the various functional components described above. For higher throughput, the video coder may be provided in an application specific integrated circuit in which the functional units described hereinabove may be provided in dedicated circuit sub-systems. The principles of the foregoing embodiments extend to a variety of hardware implementations.

The foregoing discussion has presented the operative principles in the context of a GOF, a coding entity assembled at an encoder 110 during the video coding process. Although an encoder may assign frame types according to processes described above, an encoder need not represent the GOF expressly in a coded bitstream output to a channel. Thus, it is not required, for example, that a decoder be notified of GOF boundaries via a channel. It would be sufficient for the decoder 120 to be notified regarding frame type assignments made at the encoder and to be able to decode coded frame data accordingly.

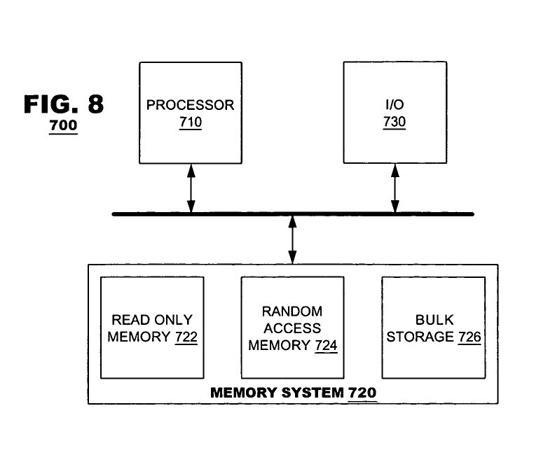

The functionality of the foregoing embodiments may be performed by various processor-based systems. One such system 700 is illustrated in the simplified block diagram of FIG. 8.

There, the system 700 is shown as being populated by a processor 710, a memory system 720 and an input/output (I/O) unit 730. The processor 710 may be any of a plurality of conventional processing systems, including microprocessors, digital signal processors and field programmable logic arrays. In some applications, it may be advantageous to provide multiple processors (not shown) in the platform 700. The processor(s) 710 execute program instructions stored in the memory system. The memory system 720 may include any combination of conventional memory circuits, including electrical, magnetic or optical memory systems. As shown in FIG. 7, the memory system may include read only memories 722, random access memories 724 and bulk storage 726. The memory system 720 not only stores the program instructions representing the various methods described herein but also can store the data items on which these methods operate. The I/O unit 730 permits data exchange with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1. A video coding method, comprising:
iteratively assigning members of a sequential series of frames for coding as non-reference frames based on common motion speed therebetween;
when a new frame from the series is detected that represents a scene cut from a preceding frame, assigning a predetermined number of frames from the sequence for coding as non-reference frames, the predetermined number including the new frame;
assigning a next frame following the last of the predetermined number of frames for coding as a reference frame; and
coding the frames according to their assignments.

2. The video coding method of claim 1, wherein the predetermined number is two.

3. The video coding method of claim 1, wherein scene cuts are detected based on a correlation coefficients computed by:
$$C = \frac{{\sum }_{i = 1}^{M} {\sum }_{j = 1}^{N} {F}_{n} ( i , j ) {F}_{n + 1} ( i , j )}{{( {\sum }_{i = 1}^{M} {\sum }_{j = 1}^{N} {F}_{n}^{2} ( i , j ) {\sum }_{i = 1}^{M} {\sum }_{j = 1}^{N} {F}_{n + 1}^{2} ( i , j ) )}^{1 / 2}} ,$$
where n, n+1 are two adjacent frames, F(•) represents a pixel value, (i,j) represents pixel locations within each frame and M, N, respectively, represent the width and weight of the frames in pixels.

4. The video coding method of claim 1, wherein the coding comprises coding each frame according to a quantization parameter that includes a base quantization parameter based on the frame's assigned type and a quantization parameter adjustment.

5. The video coding method of claim 4, wherein the quantization parameter adjustment varies based on a frame rate to be used during display of decoded video data.

6. The video coding method of claim 4, wherein the quantization parameter adjustment varies for frames in the group of frames based on each frames' distance from the scene cut.

7. The video coding method of claim 4, wherein the quantization parameter adjustment varies based on relative motion differences detected among frames before and after the scene cut.

8. The video coding method of claim 4, wherein the quantizer adjustment value varies based on correlation coefficients computed between frames in the group of frames that do not indicate presence of a scene cut.

9. The coding method of claim 1, wherein the coding further comprises coding B frames within the group of frames using spatial direct mode coding.

10. The coding method of claim 1, wherein each group of frames includes a sequence of B frames and concludes with a reference frame when considered in display order.

11. The coding method of claim 1, wherein the groups of frames have variable lengths.

12. A coding method, comprising:
detecting a scene cut between a pair of frames from a video sequence,
coding the pair of frames and at least one frame subsequent thereto as non-reference frames, and
coding another frame adjacent to the last of the non-reference frames as a reference frame.

13. The video coding method of claim 12, wherein the coding comprises coding each frame according to a quantization parameter that includes a base quantization parameter based on the frame's assigned type and a quantization parameter adjustment.

14. The video coding method of claim 13, wherein the quantization parameter adjustment varies based on a frame rate to be used during display of decoded video data.

15. The video coding method of claim 13, wherein the quantization parameter adjustment varies for frames in the group of frames based on each frames' distance from the scene cut.

16. The video coding method of claim 13, wherein the quantization parameter adjustment varies based on relative motion differences detected among frames before and after the scene cut.

17. The video coding method of claim 13, wherein the quantizer adjustment value varies based on correlation coefficients computed between frames in the group of frames that do not indicate presence of a scene cut.

18. The coding method of claim 12, wherein the coding for non-reference frames occurs according to bidirectional prediction using spatial direct mode coding.

19. A video coding method, comprising:
building groups of frames from segments of video sequences based on motion speed therein,
determining whether a group of frames includes a scene cut,
if a group of frames includes a scene cut, coding B frames within the group of frames using spatial direct mode coding.

20. The video coding method of claim 19, wherein the spatial direct mode coding comprises, for a pixelblock within a B frame:
constructing motion vectors using spatial neighbors of the current pixelblock in the same frame, and
predicting image data for the pixelblock from at least one reference frame using the constructed motion vectors.

21. The video coding method of claim 19, further comprising, if a group of frames includes a scene cut, selecting a quantization parameter adjustment for frames therein, and coding frames within the group of frames using the quantization parameter adjustment and a base quantization parameter value.

22. The video coding method of claim 21, wherein the quantization parameter adjustment varies based on a frame rate to be used during display of decoded video data.

23. The video coding method of claim 21, wherein the quantization parameter adjustment varies for frames in the group of frames based on each frames' distance from the scene cut.

24. The video coding method of claim 21, wherein the quantization parameter adjustment varies based on relative motion differences detected among frames before and after the scene cut.

25. The video coding method of claim 19, wherein scene cuts are detected based on a correlation coefficients computed by:
$$C = \frac{{\sum }_{i = 1}^{M} {\sum }_{j = 1}^{N} {F}_{n} ( i , j ) {F}_{n + 1} ( i , j )}{{( {\sum }_{i = 1}^{M} {\sum }_{j = 1}^{N} {F}_{n}^{2} ( i , j ) {\sum }_{i = 1}^{M} {\sum }_{j = 1}^{N} {F}_{n + 1}^{2} ( i , j ) )}^{1 / 2}} ,$$
where n, n+1 are two adjacent frames, F(•) represents a pixel value, (i,j) represents pixel locations within each frame and M, N, respectively, represent the width and weight of the frames in pixels.

26. The video coding method of claim 25, further comprising
selecting a quantization parameter adjustment for frames therein, the quantizer adjustment value varying for each frame based on correlation coefficients computed between the respective frame and an adjacent frame, and
coding frames within the group of frames using the quantization parameter adjustment and a base quantization parameter value.

27. The video coding method of claim 19, wherein the coding further comprises coding B frames within the group of frames using spatial direct mode coding.

28. The video coding method of claim 19, wherein each group of frames includes a sequence of B frames and concludes with a reference frame when considered in display order.

29. The video coding method of claim 19, wherein the groups of frames have variable lengths.

30. A video coder, comprising:
a scene cut detector coupled to a source of video data,
a frame type assignment unit, coupled to the source of video data,
a coding unit, coupled to the source of video data and controlled by the frame type assignment unit,
a parameter selector, responsive to indications from the scene cut detector and the frame type assignment unit, to supply coding parameter signals to the coding unit.

31. The video coder of claim 30, wherein the coding parameter signals include a quantization parameter adjustment to supplement a base quantization parameter adjustment applied by the coding unit.

32. The video coder of claim 31, wherein quantizer parameter adjustments are provided for each frame in the video sequence and quantizer parameter adjustment values are greater for frames temporally adjacent to a detected scene cut than for frames temporally more distant from the scene cut.

33. The video coder of claim 31, wherein quantizer parameter adjustments are provided for each frame in the video sequence and quantizer parameter adjustment values are greater for a sequence of frames exhibiting relatively low correlation with each other than for a sequence of frames exhibiting relatively high correlation with each other.

34. The video coder of claim 31, wherein quantizer parameter adjustments are provided for each frame in the video sequence and quantizer parameter adjustment values vary based on an expected frame rate to be used during viewing of decoded video data.

35. The video coder of claim 30, wherein the coding parameter signals include a command to code frames assigned as B frames according to spatial direct mode prediction.

36. A channel carrying coded video signals created according to a method, comprising:
detecting a scene cut between a pair of frames from a video sequence,
coding the pair of frames and at least one frame subsequent thereto as non-reference frames, and
coding another frame adjacent to the last of the non-reference frames as a reference frame.

37. The channel of claim 36, wherein the coding comprises coding each frame according to a quantization parameter that is a sum of a base quantization parameter for the frame and a quantization parameter adjustment that varies based on a frame rate to be used during display of decoded video data.

38. The channel of claim 36, wherein the coding comprises coding each frame according to a quantization parameter that is a sum of a base quantization parameter for the frame and a quantization parameter adjustment that varies based on the respective frame's distance from the scene cut.

39. The channel of claim 36, wherein the coding comprises coding each frame according to a quantization parameter that is a sum of a base quantization parameter for the frame and a quantization parameter adjustment that varies based on relative motion differences detected among frames before and after the scene cut.
